(19) United States
(12) Patent Application Publication
(10) Pub. No.: US 2019/0121597 A1
(43) Pub. Date: Apr. 25, 2019

(54) VIDEO DISPLAY PANEL AND SYSTEM

(71) Applicants: Matthew Murphy, Mukwonago, WI (US); James P. Maslowski, Wauwatosa, WI (US); Andrew D. Bendtsen, Oak Creek, WI (US)

(72) Inventors: Matthew Murphy, Mukwonago, WI (US); James P. Maslowski, Wauwatosa, WI (US); Andrew D. Bendtsen, Oak Creek, WI (US)

(21) Appl. No.: 16/171,062

(22) Filed: Oct. 25, 2018

Related U.S. Application Data
(60) Provisional application No. 62/576,710, filed on Oct. 25, 2017.

(51) Int. Cl. G06F 3/14

(52) U.S. Cl. CPC G06F 3/1446; G09G 3/3406; G09G 2370/12

(57) ABSTRACT

A system includes a video display panel (VDP). The VDP further comprises a plurality of light-emitting structures. The system further includes a T-support structure for a suspended ceiling; the T-support structure is to receive the VDP. Finally, a riser may be disposed between the VDP and the T-support structure, such that the riser is sized to receive the VDP and hold the VDP substantially flush with the T-support structure.

### PRIORITY

This application claims priority to U.S. Provisional Patent No. 62/576,710, filed on Oct. 25, 2017, the contents of which are hereby incorporated by reference.

### Field of the Invention

This invention relates generally to the art of controlling indoor environments. It also relates generally to video displays and systems that use such displays. More specifically, it relates to a video panel display that can be used to control the environment of a medical diagnostic imaging room and other venues.

### BACKGROUND

In the experience of this inventor, the present state of the art for ceiling displays are backlit static images printed on a polymeric material. These images remain constant and can only change appearance by dimming the backlight or swapping out one static image for another. In particular, static ceiling images are used extensively in healthcare facilities to relax nervous patients, expand spaces with no windows, and relieve tired workers. However, the images provide no dynamic information, which is one goal of the present invention.

### SUMMARY OF THE INVENTION

In accordance with the foregoing, this inventor has developed a 2′×2′ video display panel (VDP) that fits directly into standard North American suspended ceiling grids. The VDP could be installed into existing ceiling grids or into new ceiling grids. In application, a single 2′×2′ VDP could replace an individual ceiling tile, or multiple 2′×2′ tiles could be placed, creating a ceiling display array (CDA). The VDP could also be installed as part of a wall to create a video wall. Further, the VDP of the present invention may be configured to display from any video source, HDMI or digital photographic files from any source, including cameras, smart phones, DVD discs, Blu-Ray® discs, and computer files. Although the primary market is intended to be healthcare, the device and system of the present invention is able to be used virtually anywhere there is a suspended ceiling. It is to be understood that panels may be cut to create the 2′×2′ shape; however, the present invention also allows for the manufacture of panels of a size custom ordered by a user for the user's specific dimensional requirements. Further, although the 2′×2′ size corresponds to the standard size of North American ceiling tiles, examples are not so limited and other sizes may be used.

### BRIEF DESCRIPTION OF THE DRAWINGS

FIG. 1 is a single video display panel consistent with the present disclosure.

FIG. 2A is a system including a video display panel consistent with the present disclosure.

FIG. 2B is a system including a video display panel consistent with the present disclosure.

FIG. 3 is a 2′×2′ video display panel ceiling array consistent with the present disclosure.

### DETAILED DESCRIPTION

The 2′×2′ VDP of the present invention is capable of showing still photos, video, or any other type of content able to be displayed on a video monitor. The displayed media may be changed with a single command, accomplished locally or remotely. Further, the VDP array may be wireless connected, such as by Bluetooth®, RFID badge, Zigbee®, or other wireless communication services, to applications that display information when a smart device or smart tag is within a specified range with respect to the VDP array. A series of VDP arrays, located at strategic points within a facility, may provide a user with physical directions through the facility, relay messaging information, post warnings, guide a user to a particular location, and similar. That is, the VDP may be reactive in nature, such that proximity to the VDP may be used as an actuation means for the VDP as installed within a ceiling grid, a wall grid, or a combination.

The VDP array of the present disclosure may have a dual purpose such that it may be used for both display and for general lighting. When desired, the VDP array may be actuated to change from a general lighting mode to a video or display mode; then, when general lighting is desired, the VDP array may be returned to general lighting mode. The VDP may utilize a red-green-blue (RGB)array or an organic light-emitting diode (OLED) array to provide general lighting, which may be more efficient than a liquid crystal display (LCD).

The VDP may further be able to change its mullion settings and adjust for various widths in T-bars of the suspended ceiling grids. As a result, the content displayed by the VDP may appear more realistic to a viewer. In addition, by changing its mullion settings, the VDP is able to account for the T-bar separations with the result that the displayed content is proportional to the T-bar separations.

While in healthcare facilities, patients are often laying horizontally, with their faces directed at the ceiling. Through a VDP array located within the ceiling, a patient may be able to make video calls, watch television, or view movies. By moving this ability to the ceiling, space on the counter, floor, and wall is freed for other uses.

In some examples, eye tracking devices may be integrated within the VDP array. This may track where the patient is looking, and allow for content to be displayed in those locations. In addition, other functionalities, including internet browsing, games, and interactive programs may be available to the patient through the VDP. In some examples, this functionality may be used where patient distraction is desired, such as in a dentist's office.

Importantly, the VDP system of the present disclosure is scalable. When static images are used, a user desiring to expand the static image array must create new images for each of the existing and the new ceiling tiles to be used. As the scale grows, the cost also increases, as static images often cannot be reused. By contrast, with the VDP system of the present disclosure, expansion does not require full creation of new images but rather new VDP modules and additional programming of the controller for the expanded array dimensions.

The VDP system of the present disclosure may be realized with various technologies, including LCD, RGB array, and/or OLED. The uniqueness does not come from the type of lighting structure but rather from the fact that the panels are sized to integrate with and replace standard ceiling tiles. Further, the VDP system of the present disclosure may be powered by, for example, a Low Voltage Low Energy (LVLE) circuit or a Class 2 circuit. As a result, the VDP system of the present disclosure may be deployed in a recessed ceiling while still meeting the UL safety requirements.

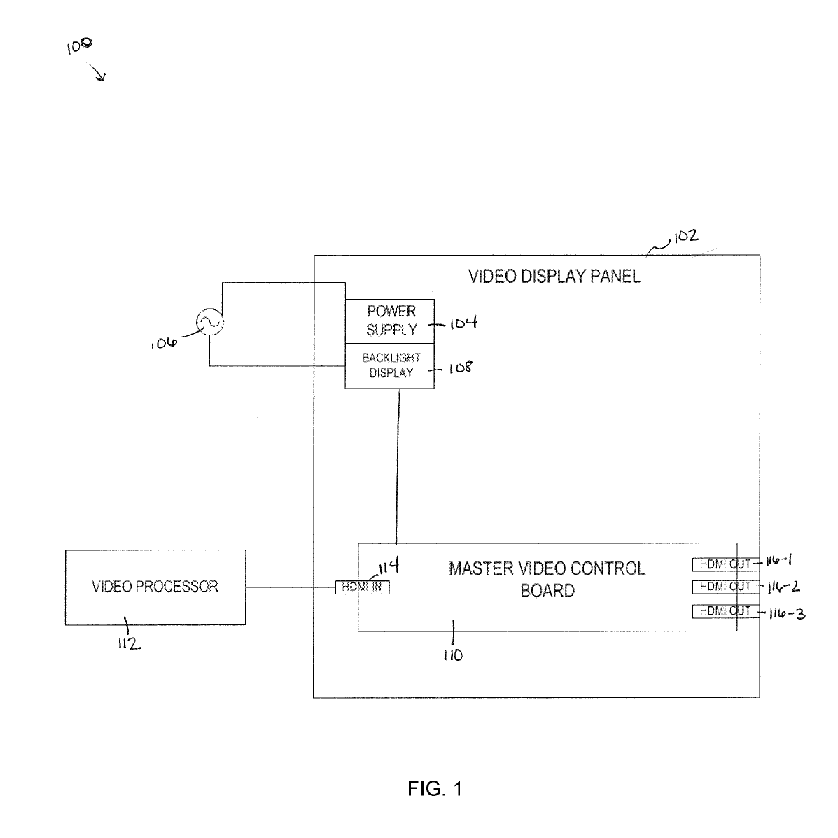

FIG. 1 is a single video display panel system 100 consistent with the present disclosure. System 100 include a VDP 102. VDP 102 includes a power supply 104, which is coupled to an alternating current (AC) source 106. AC source 106 powers VDP 102, including a back light driver 108; back light driver 108 is responsible for driving the lighting within VDP 102.

Power supply 104 is coupled to a master video control board (MVCB) 110. As used herein, an MVCB refers to the circuitry that receives video and at which the video is controlled. A video processor 112 may be coupled to the MVCB 110 by an HDMI IN port 114. Thus, MVCB 110 may receive external video via HDMI port 114. MVCB 110 may then coordinate with external controllers, such as a computer or smart phone, to display the video to a patient who is viewing the VDP 102.

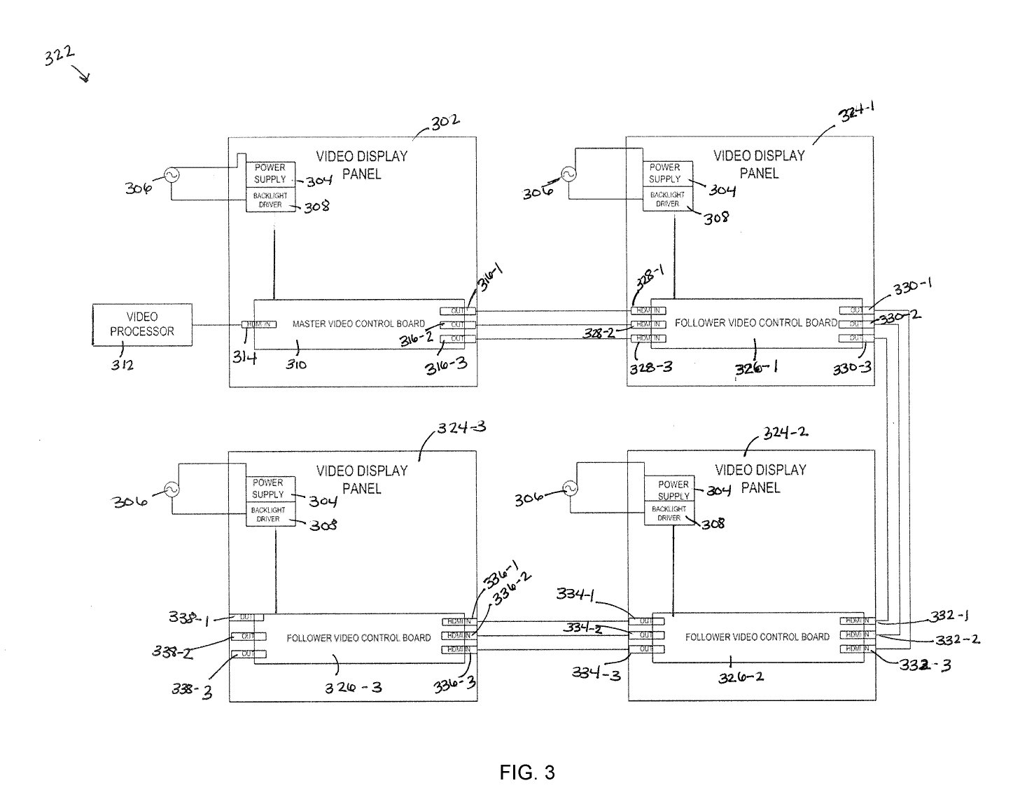

A plurality of HDMI OUT ports 116-1, 116-2, 116-3 (collectively, HDMI OUT ports 116) may be coupled to the MVCB 112. HDMI OUT ports 116 may allow for VDP 102 to be coupled to other VDPs to create a VDP array. This is discussed further herein with respect to FIG. 3.

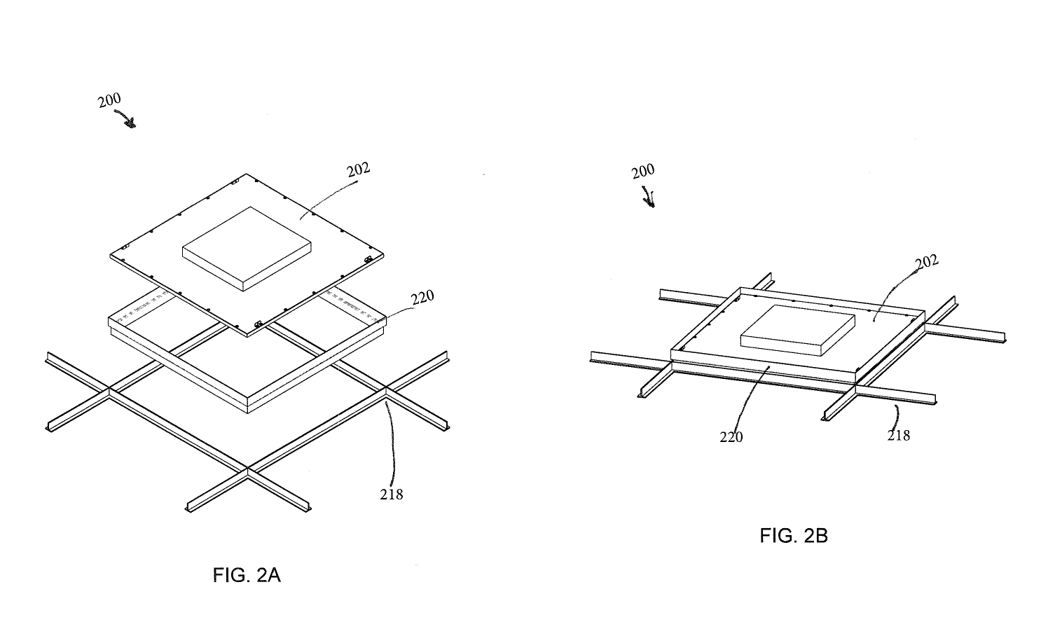

FIG. 2A is a system 200 including a video display panel 202 consistent with the present disclosure. VDP 202 may be akin to VDP 102, discussed with respect to FIG. 1, and may include the internal hardware discussed therein. As shown in FIG. 2A, VDP 202 is designed to engage with a suspended ceiling structure. More particularly, VDP 202 is designed to engage with a T-bar structure 218. As shown in FIG. 2A, T-bar structure 218 may be substantially square in shape; VDP 202, therefore, may be identically shaped so as to engage with T-bar structure 218 with a minimum amount of gaping or space. In some examples, a riser 220 may be inserted between VDP 202 and T-bar structure 218. Riser 220 may provide additional protection and structure upon which VDP 202 is able to engage, thus reducing the likelihood of VDP 202 failing to couple to T-bar structure 218.

FIG. 2B is a system 200 including a video display panel 202 consistent with the present disclosure. FIG. 2B shows VDP 202 fully installed as part of system 200. As shown in FIG. 2B, VDP 202 rests flush with riser 220 and T-bar structure 218. Thus, VDP 202, is able to substantially replace a standard suspended ceiling tile.

FIG. 3 is a 2′×2′ video display panel ceiling array 322 consistent with the present disclosure. Although FIG. 3 shows a series of four 2′×2′ VDPs, examples are not so limited, and more or fewer VDPs may be used. Array 322 includes a first VDP 302. First VDP 302 may be akin to VDP 102 and 202, discussed with respect to FIGS. 1 and 2, respectively. Within array 322, first VDP 302 may be referred to as a master panel, meaning that first VDP 302 may be the primary VDP, with other VDPs coupled thereto. First VDP 302 may include a power supply 304, which may be coupled to an AC source 306 and to a backlight driver 308. As discussed with respect to FIG. 1, AC source 306 may provide current to power supply 304, thus enabling power supply 304 to provide power to VDP 302.

VDP 302 may further include an MVCB 310. MVCB 310 may be akin to MVCB 110, discussed with respect to FIG. 1. As discussed with respect to FIG. 1, MVCB 310 may be able to receive and accept input video from a video processor 312. The input video may be transmitted to MVCB 310 from video processor 312 via an HDMI IN port 314. However, examples are not so limited, and other means of transmission may be used, including wireless or fiber optics. A plurality of HDMI OUT ports 316-1, 316-2, 316-3 (collectively, HDMI OUT ports 316) may further be coupled to MVCB 310. HDMI OUT ports 316 may enable first VDP 302 to be coupled to further VDPs.

Array 322 may further include a second VDP 324-1. Second VDP 324-1 may be similar to first VDP 302; however, second VDP 324-1 may be referred to as a follower VDP. As used herein, a follower VDP refers to a VDP that is coupled to a master VDP such that the follower VDP receives video from and is controlled by the master VDP. Second VDP 324-1 may include a power supply 304 coupled to an AC source 306, and may further include a backlight driver 308. A follower video control board (FVCB) 326-1 may be coupled to power supply 304. As used herein, an FVCB refers to a video control board that is unable to receive or accept input video from an external source; rather the FVCB is coupled to an MVCB (such as MVCB 310), which may assign an identifier to the FVCB to provide correct and accurate transmission and scaling.

FVCB 326-1 may include a plurality of HDMI IN ports 328-1, 328-2, 328-1 (collectively, HDMI IN ports 328). HDMI IN ports 328may be coupled to HDMI OUT ports 316, located on first VDP 302. Thus, VDP 324-1 may receive video from VDP 302. FVCB 326-1 may further include a plurality of HDMI OUT ports 330-1, 330-2, 330-3 (collectively HDMI OUT ports 330).

A third VDP 324-2 may be included within array 322. Third VDP 324-2 may be akin to second VDP 324-1; that is, third VDP 324-2 may be a follower VDP. Like first VDP 302 and second VDP 324-1, third VDP 324-2 may include a power supply 304 coupled to an AC source 306 and including a backlight display 308. Third VDP 324-2 may further include an FVCB 326-2.

Third VDP 324-2 may be coupled to second VDP 324-1 at a plurality of HDMI IN ports 332-1, 332-2, 332-3 (collectively, HDMI IN ports 332). HDMI IN ports 332 may be coupled to HDMI OUT ports 330, located on second VDP 324-1. As with HDMI IN ports 328, HDMI IN ports 332 may receive input in the form of a video or other information from second VDP 324-1, which is in turn receiving the information from first VDP 302. Third VDP 324-2 may further include a plurality of HDMI OUT ports 334-1, 334-2, 334-3 (collectively, HDMI OUT ports 334).

Array 322 may further include a fourth VDP 324-3. Third VDP 324-2 may be akin to second VDP 324-1 and third VDP 324-2; that is, fourth VDP 324-3 may be a follower VDP. Like first VDP 302 and second and VDP2 324-1, 324-2, fourth VDP 324-3 may include a power supply 304 coupled to an AC source 306 and including a backlight display 308. Fourth VDP 324-3 may further include an FVCB 326-3.

Fourth VDP 324-3 may be coupled to third VDP 324-2 at a plurality of HDMI IN ports 336-1, 336-2, 336-3 (collectively, HDMI IN ports 336). HDMI IN ports 336may be coupled to HDMI OUT ports 334 of third VDP 324-2. As with HDMI IN ports 332, HDMI IN ports 336 may receive input in the form of a video or other information from third VDP 324-2, which is in turn receiving the information from second VDP 324-1. Fourth VDP 324-3 may further include a plurality of HDMI OUT ports 338-1, 338-2, 338-3 (collectively, HDMI OUT ports 338). In FIG. 3, HDMI OUT ports 338 are not connected to further VDPs; however, due to the scalability of array 322, HDMI OUT ports 338 may be coupled to a fifth VDP should a user desire to increase the array.

The present embodiment includes a standard LCD cell cut to fit the standard 2′×2′ dimension for a suspended ceiling tile. Each LCD (VDP) has an effective resolution of 2160×2160 pixels, such that two VDPs may combined to be equivalent to a 4k UHD monitor. If, for example, a 2′×4′ VDP array is created, the effective monitor is 4′×8′ (or roughly a 107 inch diagonal) and has 8k resolution. In addition when an array is created, individual VDPs may be identified as right panels or left panels; this may occur, for example through use of a 51 pin LVDS, with an unused pin being pulled either high or low to identify if it's a right or left VDP. The master VDP may then identify the panel as right or left. This allows for slicing and rotation of the video stream to accommodate for the VDP's cell type and position, as well as for any other post manipulation required. Further, panels may be cut to create the 2′×2′ shape or may be manufactured to a user's particular specifications.

In the foregoing detailed description of the present disclosure, reference is made to the accompanying drawings that form a part hereof, and in which are shown by way of illustration how examples of the disclosure may be practiced. These examples are described in sufficient detail to enable those of ordinary skill in the art to practice the examples of this disclosure, and it is to be understood that other examples may be utilized and that process and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and relative scale of the elements provided in the figures are intended to illustrate the examples of the present disclosure and should not be taken in a limiting sense.

1. A system, comprising:
a video display panel (VDP), the VDP further comprising a plurality of light-emitting structures;
a T-support structure for a suspended ceiling, wherein the T-support structure is to receive the VDP;
a riser disposed between the VDP and the T-support structure, wherein the riser is sized to receive the VDP and hold the VDP substantially flush with the T-support structure.

2. The system of claim 1, wherein the VDP further comprises:
a power supply;
an alternating current (AC) source coupled to the power supply;
a backlight driver coupled to the power supply and to the plurality of light-emitting structures;
a master video control board (MVCB);
a video processor coupled to the MVCB at an HDMI IN port; and
a plurality of HDMI OUT ports coupled to the MVCB.

3. The system of claim 2, wherein:
the MVCB receives an input from the video processor;
the MVCB scales the received input; and
the MVCB displays the scaled input on the VDP.

4. The system of claim 1, wherein the VDP is sized to replace a suspended ceiling tile.

5. The system of claim 4, wherein the VDP is sized to replace the suspended ceiling tile at the T-support structure.

6. The system of claim 1, wherein the VDP is one of:
an LCD display;
an OLED display; or
an RGB display.

7. A system, comprising:
a first VDP, wherein:
the first VDP is a master VDP; and
the first VDP receives an input from a video processor;
a second VDP coupled to the first VDP at a first plurality of HDMI ports, wherein the second VDP is a follower VDP;
a third VDP coupled to the second VDP at a second plurality of HDMI ports, wherein the third VDP is a follower VDP; and
a fourth VDP coupled to the third VDP at a third plurality of HDMI ports, wherein the fourth VDP is a follower VDP.

8. The system of claim 7, wherein each VDP further comprises:
a power supply;
an AC source coupled to the power supply;
a backlight driver coupled to the power supply;
a plurality of HDMI IN ports; and
a plurality of HDMI OUT ports.

9. The system of claim 7, wherein the first VDP further comprises:
an MVCB; and
a video processor coupled to the MVCB at a first HDMI IN port.

10. The system of claim 7, wherein the second VDP, the third VDP, and the fourth VDP each further comprise:
a follower video control board (FVCB);
a plurality of HDMI IN ports to couple to another VDP; and
a plurality of HDMI OUT ports to couple to another VDP.
